(19) United States
(12) Patent Application Publication
(10) Pub. No.: US 2021/0317014 A1
(43) Pub. Date: Oct. 14, 2021

(54) METHODS AND SYSTEMS FOR CONTROLLING BACTERIA IN BIOFILMS

(71) Applicant: CHEMTREAT, INC., Glen Allen, VA (US)

(72) Inventors: Chris D. BARON, Newark, DE (US); Jeffrey M. DOTSON, Perdido Key, FL (US); Jon J. COHEN, Naperville, IL (US)

(73) Assignee: CHEMTREAT, INC., Glen Allen, VA (US)

(21) Appl. No.: 17/137,527

(22) Filed: Dec. 30, 2020

Related U.S. Application Data
(60) Provisional application No. 63/008,945, filed on Apr. 13, 2020.

(51) Int. Cl. C02F 1/50; C02F 1/68; A01N 59/00

(52) U.S. Cl. CPC C02F 1/50; C02F 1/68; A01N 59/00; C02F 2103/16; C02F 2303/22; C02F 2305/02; C02F 2209/29; C02F 2303/04

(57) ABSTRACT

Methods and systems are described for treating water in a water system that includes a biofilm with acid-producing bacteria. The biofilm can be treated, reduced, or eliminated by adding chlorite to the water and reacting the chlorite with acid generated by the acid-producing bacteria to form chlorine dioxide. The chlorine dioxide is thus formed in situ localized to the biofilm, and can be effective to kill bacteria in the biofilm.

### TECHNICAL FIELD

This disclosure relates generally to controlling bacteria in biofilms, including sludge in process waters, and more specifically to controlling the formation and growth of such biofilms by adding chlorite to the water.

### BACKGROUND

Biofouling is a detrimental type of fouling experienced in industrial water treatment applications. Regardless of industry, water treatment experts spend a considerable amount of time focused on preventing biofouling of heat exchangers, cooling towers, process water storage vessels, and other areas serviced by various industrial cooling and process waters. One particularly difficult form of biofouling occurs when large collections of groups of sessile bacterial cells adhere to a surface in process equipment or conduits to produce a biofilm, or otherwise congregate in a collective mass as sludge. Biofilms can cause process equipment to perform poorly and can produce acid that causes corrosion. Uncontrolled corrosion on metal surfaces can lead to unplanned downtime and accelerated capital expenditures. Thus, biofilms can lead to substantial costs and lost revenues.

The use of biocides, such as chloramines, for microbiological control in industrial applications is known. Chloramine solutions are used as a cleaning agent or as a biocide for cooling and process waters. Chloramines can provide protection against microbial contamination and can penetrate and reduce biofilms in process waters. However, chloramine is a relatively weak oxidizer and in many cases may not be effective in managing difficult or thicker biofilms.

### SUMMARY

It is an object of the disclosed embodiments to provide an effective solution for attacking biofilms by the addition of chlorite to the biofilm-containing water.

In one aspect, this disclosure provides a method for treating water in a water system that includes a biofilm with acid-producing bacteria. The method includes steps of adding chlorite to the water, and reacting the chlorite with acid produced by the acid-producing bacteria to form chlorine dioxide.

### BRIEF DESCRIPTION OF THE DRAWINGS

FIG. 1 is a photograph showing the results of an experiment in which chlorite and chloramine are added to cooling water;

FIG. 2 is another photograph showing the results of the experiment in which chlorite and chloramine are added to the cooling water; and

FIG. 3 is a photograph showing the results of a second experiment in which chlorite and chloramine are added to the cooling water.

### DETAILED DESCRIPTION OF EMBODIMENTS

This disclosure provides systems and methods for controlling biofilms in process waters by adding chlorite. The IUPAC definition of a “biofilm” is an aggregate of microorganisms in which cells that are frequently embedded within a self-produced matrix of extracellular polymeric substances (EPSs) adhere to each other and/or to a surface. Biofilms are typically irreversibly associated (i.e., not removed by gentle rinsing) with a surface and enclosed in a matrix of primarily polysaccharide material. As used hereinafter in this application, the term “biofilm” incorporates this IUPAC definition and also includes sludges, which are congregations of bacteria and other extraneous materials that have similar properties as biofilms though not necessarily adhered to a surface.

As indicated above, bacteria are often present in waters used in industrial processes, such as heat exchanger and cooling tower waters. Free swimming bacteria in the water are referred to as planktonic bacteria. When these bacteria form biofilms they are referred to as sessile bacteria. The sessile bacteria in biofilms take on substantially different attributes than their planktonic counterparts, including transcribing different genes. Sessile bacteria also operate in an oxygen deficient environment and become anaerobic in a biofilm. This can cause certain bacteria to produce acid as a byproduct of their metabolism.

The biofilms can include nitrifying bacteria including those that convert ammonia to nitrite and those that convert nitrite to nitrate, collectively referred to as Nitrifying bacteria. Nitrifying bacteria can produce acid, which is problematic because it creates corrosion, as discussed above. It is also believed that the acid and other metabolic byproducts could neutralize chloramines and render them ineffective to attack the biofilm. Chlorine dioxide is not sensitive to ammonia but is rapidly neutralized by nitrite. Nitrifying bacteria are thus more resistant to traditional biocides than other species. It has also been discovered that bacteria such as sulfate reducing bacteria in biofilms are very problematic. Sulfate reducing bacteria reduce sulfate to sulfide (H₂5 or S²⁻), which is a strong reducer that can neutralize halogen-based oxidizing biocides, and the acid produced can cause aggressive corrosion.

In one aspect, this invention is directed to the addition of chlorite into process waters that include biofilms to reduce or control the biofilm. Chlorite is normally used as precursor to make chlorine dioxide, which is a known biocide. Chlorite itself has minimal toxicity and is not used as a biocide. It has been discovered that chlorite can provide an effective remedy against biofilms by using the acid produced by certain acid-producing sessile bacteria in the biofilm. The acid that is generated by the biofilm can be locally concentrated around the biofilm (e.g., pH at metal surfaces having biofilms can be in the range of 1.5 to 4, or 2 to 3), and this concentrated acid can react with the chlorite in the process water or within the biofilm to produce chlorine dioxide. In turn, the chlorine dioxide will kill the bacteria. Moreover, chlorine dioxide is a unique oxidizer because if it is neutralized by reducing bacteria, it will convert to chlorite, which will convert back to chlorine dioxide in the presence of acid that is produced by the biofilm. This method thus can produce a regenerating and effective oxidizing biocide in situ at the site of the biofilm by reacting chlorite with the acid byproduct formed by the bacteria. The ability to form localized chlorine dioxide at the site of the biofilm allows the use of relatively low amounts of chlorite since the chlorine dioxide is only generated at the site in the water system where it is needed. This discovery is surprising, particularly since bulk chlorite in water has minimal toxicity. As is apparent from the foregoing description, the chlorite treatment described herein excludes chlorite that is added and then anthropogenically converted to chlorine dioxide.

The chlorite treatment can be added to any waters that include acid-producing biofilms. For example, the chlorite treatment can be used to attack biofilms that have bacterial populations that are greater than 10⁶ CFU/ml, such as 10⁷ to 10¹⁰ CFU/ml or 10⁸ to 10⁹ CFU/ml. In contrast to conventional biocide treatments, the chlorite treatment is believed to be particularly effective to reduce biofilms with significant populations of nitrifying bacteria and/or reducing bacteria for the reasons explained above. The chlorite treatment can be effective to reduce the bacterial population in the treated water by at least a factor of 10, at least a factor of 50, or at least a factor of 100. For example, after the chlorite treatment, the treated water can have a bacterial population that is less than 10⁵ CFU/ml, such as less than 10⁴, or from 10³ to 10⁴ CFU/ml, for example.

The treatment can be used in any water environment that includes biofilms such as in heat exchangers, cooling towers, conduits, process water storage vessels, pits, lagoons, and sumps. The water may be wastewater, such as water that is a byproduct of domestic, industrial, commercial or agricultural activities, including domestic wastewater from households, municipal wastewater from communities (also called sewage) and industrial wastewater.

In one aspect, the chlorite can be added in sufficient amounts to reduce the mass of existing biofilms, which may correspond to amounts of 0.25 ppm to 50 ppm, from 0.5 ppm to 30 ppm, from 1 ppm to 10 ppm, or from 2 to 5 ppm (based on the amount of chlorite ion in the water). In wastewater applications, the amount of chlorite may be higher, such as 1 ppm to 100 ppm, from 2 ppm to 50 ppm, or from 5 ppm to 25 ppm, or from 2 to 5 ppm (based on the amount of chlorite ion in the water). The amount of chlorite added may be varied based on time of day, such as for wastewater where the need for biocide may vary throughout the day. In another aspect, the chlorite can be added in sufficient amounts to generate chlorine dioxide in the treated water in amounts of 0.1 ppm to 10 ppm, 0.25 ppm to 5 ppm, or 0.5 ppm to 2 ppm as measured by the DPD Free Chlorine method after feeding the chlorite dose to the treatment water. The chlorite can be added to the biofilm-containing water in bulk as a solid or as an aqueous solution (e.g., chlorite salt solutions that include the chlorite salt in amounts of from 5 to 60 wt. %, 10 to 40 wt. %, or 20 to 30 wt. %).

The chlorite can be stored in a tank or other storage container, and can be pumped or metered into the water system as needed and in the desired amounts. The addition of chlorite can be automated by using a controller that sends signals to equipment such as pumps and valves that are connected to the chlorite storage container. The controller can receive input signals from sensors in the water system that detect the presence of a biofilm, e.g., by measuring corrosion rates. The controller can be programmed to automatically begin dosing chlorite into the water system if corrosion rates exceed a threshold level or if other indicia of biofilms are present. The dosing schedule can be based on a schedule that is stored in a memory or can be based on a control feedback loop based on sensor input.

The chlorite can be added at any suitable location in the water system where the chlorite will react with the acid from the acid-producing bacteria of the biofilm, including adding it at the location of the biofilm (e.g., adding directly to sump water to treat sump sludge) or upstream of the location of the biofilm.

The chlorite treatment can be applied to the water on a continuous basis, a periodic basis, or an intermittent basis. In practice, at the beginning of a treatment program, the chlorite can be fed at 1 to 20 doses per day, 2 to 10 doses per day, or 3 to 5 doses per day, and may be fed until the biofilm decreases to the desired level or until measured corrosion levels are reduced to a threshold level. In recirculating water systems, each of these doses can persist for 1-5 turns of the system, or 2 to 3 turns of the system. If the chlorite treatment is continued until the biofilm is removed entirely, the chlorite treatment can be suspended until the free swimming bacteria again form the biofilm. In this regard, because the acid-producing bacteria in the biofilm produce acid that reacts with the chlorite to form ClO₂, the efficacy of the chlorite treatment depends on the presence of the acid-forming bacteria.

The chlorite treatment can be used in combination with one or more treatment programs that use another biocide, including oxidizing and nonoxidizing biocides. For example, co-treatments can include one or more of chloramines. Chloramines can be useful to control the amounts of planktonic bacteria and may be effective in helping reduce the frequency of biofilm reformation. Chloramines may include monochloramine, dichloramine, trichloramine, and organic chloramines. Doses of chloramine may range from a continuous level of 0.25 ppm to 25 ppm, 0.5 ppm or up to 10.0 ppm, or 1 ppm to 5 ppm, expressed in terms of total oxidizing chlorine. One or more chloramines can be added to the water continuously or at least semi-continuously to maintain a threshold minimum concentration of chloramine in the water. The chlorite treatment can enable the use of lower doses of chloramine than would otherwise be needed in the absence of chlorite.

In some embodiments, the methods and system are used without separately adding chlorine dioxide to the water.

### EXAMPLES

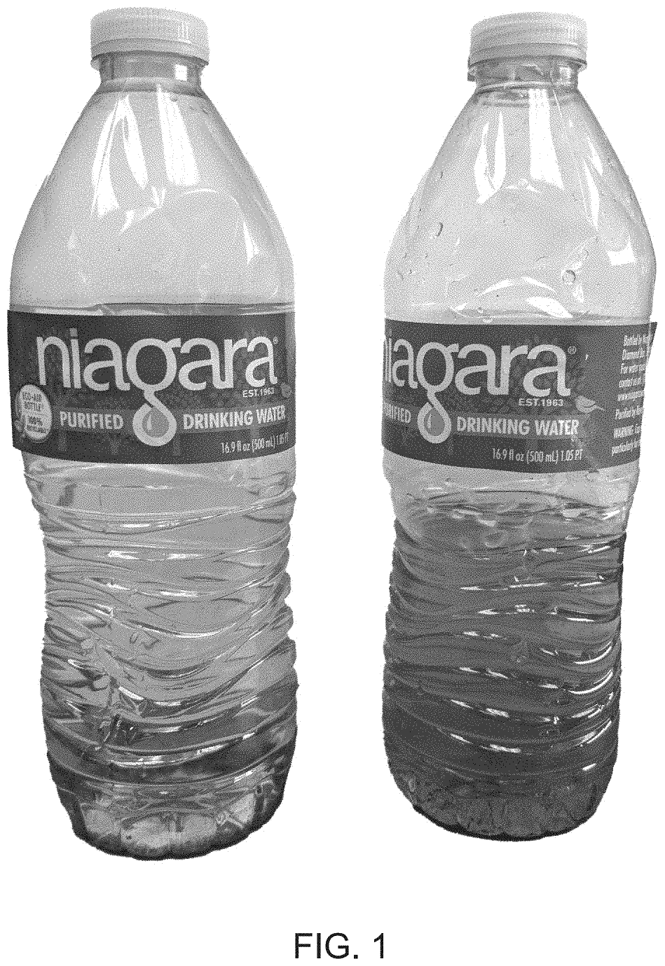

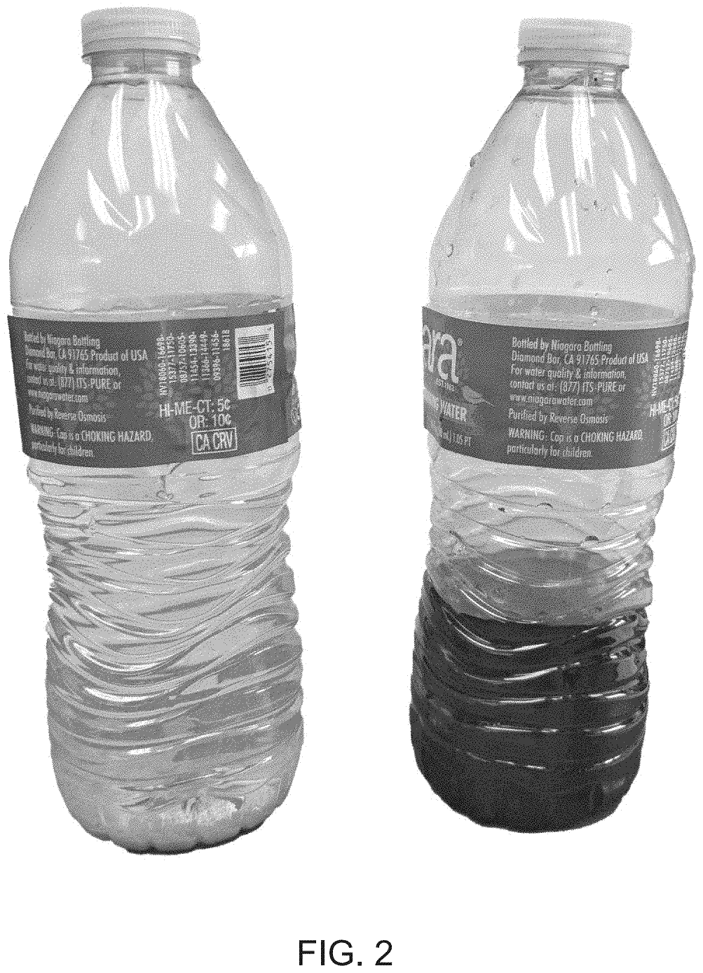

FIGS. 1 and 2 are photographs showing the results of a field trial experiment conducted at a steel making facility in the lower Midwestern United States. This site was previously utilizing a chloramine-based disinfection program, but suffered from build-up of sludge due to the presence of high levels of Total Suspended Solids that would settle out in areas of slow velocity. In this experiment, cooling water from the hotwell outlet was treated. The cooling water contained sulfate reducing bacteria (SRB). In FIGS. 1 and 2 the bottle on the right is a sample of water treated only with chloramine and the bottle on the left is a sample of water treated with chlorite and chloramine. For the treated water, a treatment dose of chlorite salt solution (25% wt./wt.) was periodically added to the treatment water for a duration of 90 minutes every 11 hours. The dose was effective to provide an amount of chlorite in the treated water in a range of 1 to 10 ppm chlorite ion. The chlorite concentration was calculated based on the system volume. Slug feeds of chloramine were also added to both the treated and untreated water twice daily to achieve 2-5 ppm chloramine as total oxidizing chlorine. FIG. 1 shows the results of the treatment after the water was treated and then the sample was allowed to sit for about 14 hours. FIG. 2 shows the results of the treatment after the sample was collected and allowed to sit for 30 minutes. In this regard, the untreated water sample on the right is darker in FIG. 2 as compared to FIG. 1 because it did not have as long to settle. Residual chlorine dioxide of the treated water produced 1.05 ppm chlorine dioxide as measured by using the DPD-based free chlorine method. The water that was not treated with chlorite produced 0 ppm chlorine dioxide as measured with the DPD free chlorine method. Thus, this experiment shows that the addition of chlorite to sludge-containing water generates chlorine dioxide gas in situ from the combination of acid and chlorite within the sludge. The photographs also show that the chlorine dioxide reacting with the bacteria caused enhanced coagulation of the solids in the water. The treated sample also exhibited a chlorine-like odor as compared to the anaerobic odor from the untreated water.

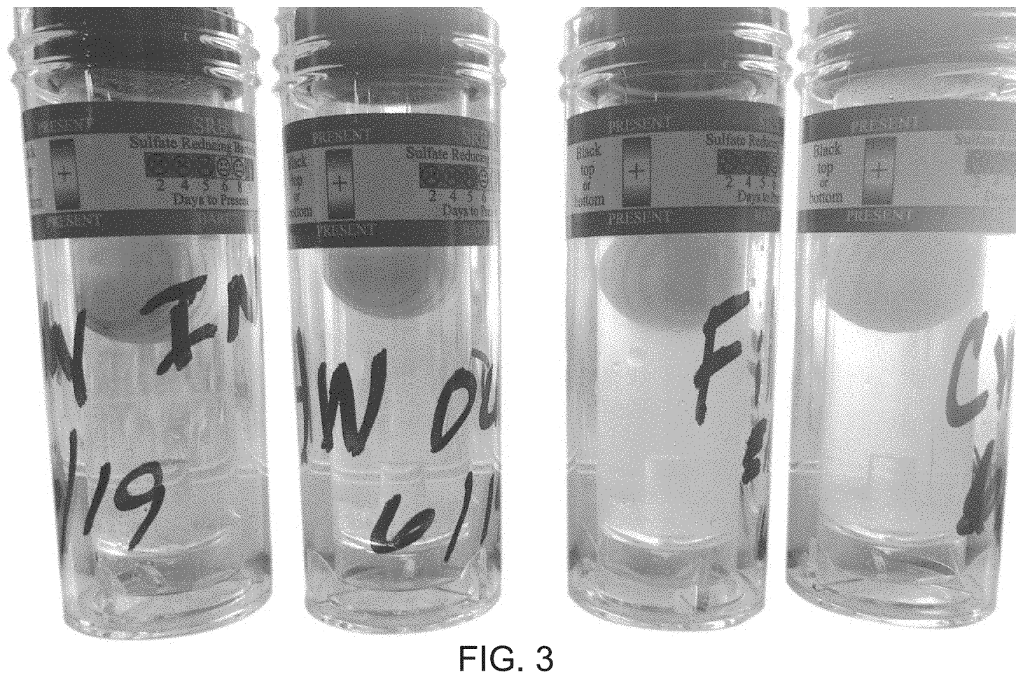

FIG. 3 is a photograph showing the results of a second field trial experiment. Samples of the process water were collected in BART™ Sulfate-Reducing Bacteria vials to observe the behavior of this class of bacteria after exposure to the monochloramine-chlorite treatment program described above in connection with FIGS. 1 and 2. From left to right in FIG. 3, the treated samples are taken from the hotwell inlet, the hotwell outlet, filter effluent, and cold well. Previous to the addition of chlorite, the SRB bacteria population was high enough to cause severe discoloration of the vials in less than 3 days, which is indicative of severe contamination. The bacteria population prior to treatment was about 0.5 MM-2.2 MM cfu/ml. Three days after co-treatment with monochloramine and chlorite, the vials are still substantially clear, indicating at least a 2-log reduction in bacteria levels. The bacterial level after the treatment was about 0.000325 MM-0.006 MM cfu/ml. FIG. 3 shows the samples 3 days after treatment. Total oxidizing chlorine values measured using the DPD-based Total Oxidizing Chlorine test were: 0.45 ppm at hotwell outlet; 0.28 ppm at hotwell inlet; 0.15 ppm at filter effluent; and 0.65 ppm at the cold well. This is a measure of the monochloramine content. The free chlorine dioxide values measured using the DPD-based Free Oxidizing Chlorine test are 0.61 ppm at the hotwell outlet; 0.44 ppm at the hotwell inlet; 0.15 ppm at the filter effluent; and 0.42 ppm at the cold well.

It will be appreciated that the above-disclosed features and functions, or alternatives thereof, may be desirably combined into different systems or methods. Also, various alternatives, modifications, variations or improvements may be subsequently made by those skilled in the art, and are also intended to be encompassed by the disclosed embodiments. As such, various changes may be made without departing from the spirit and scope of this disclosure.

What is claimed is:

1. A method for treating water in a water system that includes a biofilm with acid-producing bacteria, the method comprising:
adding chlorite to the water;
adding a biocide to the water; and
reacting the chlorite with acid produced by the acid-producing bacteria to form chlorine dioxide.

2. The method of claim 1, wherein the chlorite is added in an amount that is in the range of 0.25 ppm to 50 ppm based on the weight of chlorite ion in the water.

3. The method of claim 1, wherein the biofilm has a bacterial population that is greater than 10⁶ CFU/ml prior to the addition of the chlorite.

4. The method of claim 1, wherein the biofilm includes nitrifying or denitrifying bacteria.

5. The method of claim 1, wherein the biofilm includes iron-reactive bacteria.

6. The method of claim 5, wherein the reducing bacteria include sulfate-reducing bacteria.

7. The method of claim 1, wherein the chlorite is added to the water in periodic or intermittent doses.

8. The method of claim 1, wherein the doses are added at dosing intervals ranging from 1-24 doses per day.

9. The method of claim 8, wherein the water system is a recirculating water system, and the duration of each dose lasts for 1-5 turns of the system.

10. The method of claim 1, wherein the chlorite is added to the water as an aqueous solution of from 5 to 60 wt. % chlorite salt.

11. The method of claim 1, wherein the biocide comprises a chloramine.

12. The method of claim 11, wherein the chloramine is added to the water in a manner such that a threshold minimum concentration of chloramine in the water is continuously maintained.

13. The method of claim 11, wherein the chloramine is added to the water in periodic doses such that the amount of chloramine in the water reaches a minimum threshold level for a proscribed time.

14. The method of claim 1, wherein, aside from the reacting step, chlorine dioxide is not separately added to the water system.

15. The method of claim 1, wherein a sufficient amount of chlorite is added to the water to reduce the bacterial population of the treated water by at least a factor of 10.

16. The method of claim 1 wherein the water is wastewater.

17. The method of claim 16, wherein the chlorite is added in an amount that is in the range of 1 ppm to 100 ppm based on the weight of chlorite ion in the water.

18. The method of claim 17, wherein the amount of chlorite added is varied based on time of day.
